(19) United States
(12) Patent Application Publication
(10) Pub. No.: US 2010/0295423 A1
(43) Pub. Date: Nov. 25, 2010

(54) Belt-driven Generator

(76) Inventors: Chi-Chang Hsiao, Tanzih Township (TW); Hua-Ming Hsu, Tanzih Township (TW); Qing-Zhi Ding, Tanzih Township (TW); Jun-Hong Liu, Tanzih Township (TW)

Correspondence Address: Dr. BANGER SHIA;Patent Office of Bang Shia, 102 Lindencrest Ct., Sugar Land, TX, 77479-5201, US

(21) Appl. No.: 12/783,652

(22) Filed: May 20, 2010

(30) Foreign Application Priority Data
May 21, 2009 (TW) 098116934

(51) Int. Cl. H02K 7/10

(52) U.S. Cl. 310/75 R

(57) ABSTRACT

A belt-driven generator essentially comprises a stator and a rotor. The rotor exteriorly includes a driving annular surface. With the driving annular surface, the rotor can be directly connected to the belt and driven by the drive unit, thus reducing vibration and noise while extending the service life of the generator. In addition, the part cost, the assembly cost and the assembly space of the generator can be reduced.

### BACKGROUND OF THE INVENTION

1. Field of the Invention

The present invention relates to a generator; and more particularly to a belt-driven generator.

2. Description of the Prior Art

Referring to FIG. 1, a conventional generator 10 comprises a stator 11 having an inner peripheral surface provided with plural equally-spaced permanent magnets 12. The stator 11 is pivotally mounted on a rotating shaft 14 through a bearing 13 thereon. The rotating shaft 14 is provided with plural equally-spaced rotor coils 15 correspondingly to the permanent magnets 12. The rotating shaft 14 is further provided on an external end thereof with a drive wheel 16, and the drive wheel 16 is driven by a drive unit 18 through a belt 17, so that the respective rotor coils 15 can rotate relative to the permanent magnets 12 with the rotation of the rotating shaft 14, thereby, the rotor coils 15 can magnetically interact with the permanent magnets 12 to generate electric power. However, the conventional generator 10 still suffers from the following drawbacks in practice use:

1. As for the generation of the electric power, besides the mutual interaction of the rotor coils 15 and the permanent magnets 12, the generator 10 further needs the drive wheel 16 at the external end of the rotating shaft 14 to be drivingly connected to the drive unit 18 through the belt 17, nevertheless, since the drive wheel 16 and the belt 17 are spaced apart, in other words, the pivoting position of the generator 10 (namely, the position where the rotor coils 15 are pivotally connected to the stator 11 through the rotating shaft 14) and the driven position (the engagement position of the drive wheel 16 and the belt 17) are transversely spaced by a certain distance, as a result of this, when the drive wheel 16 is driven by the drive unit 18, the generator 10 will vibrate, producing noise or adversely affecting the service life of the generator 10. Particularly, the farther the drive wheel 16 is from the stator 11, namely the longer the rotating shaft 14 is, the vibration of the generator 10 is more obvious.

2. Since the external end of the rotating shaft 14 has to be provided with a drive wheel 16, the rotating shaft 14 can be driven by the drive unit 18 in the end, and the rotor coils 15 can interact with the permanent magnets 12 to produce electric power, it can be seen from this that the structure design of the conventional generator 10 is bad that the additional drive wheel 16 increases the part cost and assembly cost, and the external end of the rotating shaft 14 protruding out of the stator 11 causes the generator 10 to occupy large assembly space.

The present invention has arisen to mitigate and/or obviate the afore-described disadvantages.

### SUMMARY OF THE INVENTION

The primary objective of the present invention is to provide a belt-driven generator which comprises a rotor which is directly driven by a belt so as to reduce vibration and noise while extending the service life of the generator.

The secondary objective of the present invention is to provide a belt-driven generator which comprises a rotor which is directly driven by a belt so as to reduce the part cost, the assembly cost and reduce the assembly space.

Hence, to achieve the above objectives, a belt-driven generator in accordance with the present invention is drivingly connected to a belt and comprises a stator and a rotor. The stator is interiorly provided with a bearing and exteriorly includes a stator magnetic field. The rotor includes a lateral surface, and a shaft portion extending from a center of the lateral surface to be inserted into the bearing of the stator. The lateral surface is provided with an annular protrusion extending from a circumference thereof, and the annular protrusion includes a rotor magnetic field on an inner annular surface thereof. An outer annular surface of the annular protrusion is a driving annular surface, and the driving annular surface is drivingly connected to the belt in a contact manner so as to allow the rotor to be directly driven to rotate relative to the stator.

### BRIEF DESCRIPTION OF THE DRAWINGS

FIG. 1 is a cross-sectional view of a conventional generator;

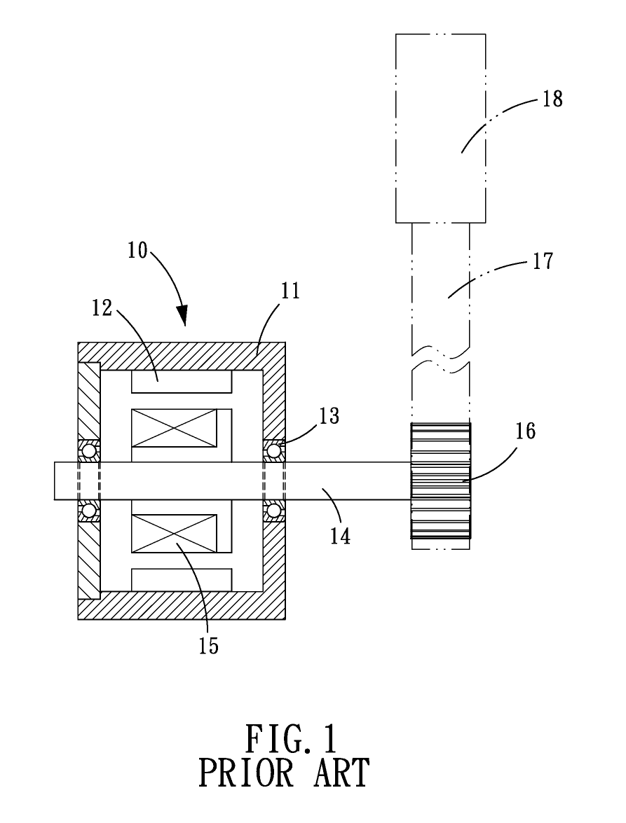

FIG. 2 is an exploded view of a belt-driven generator in accordance with the present invention;

FIG. 3 is a cross-sectional view of the belt-driven generator in accordance with the present invention;

FIG. 4 is an operational view of the belt-driven generator in accordance with the present invention; and

FIG. 5 is a schematic view showing a belt-driven generator in accordance with another embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

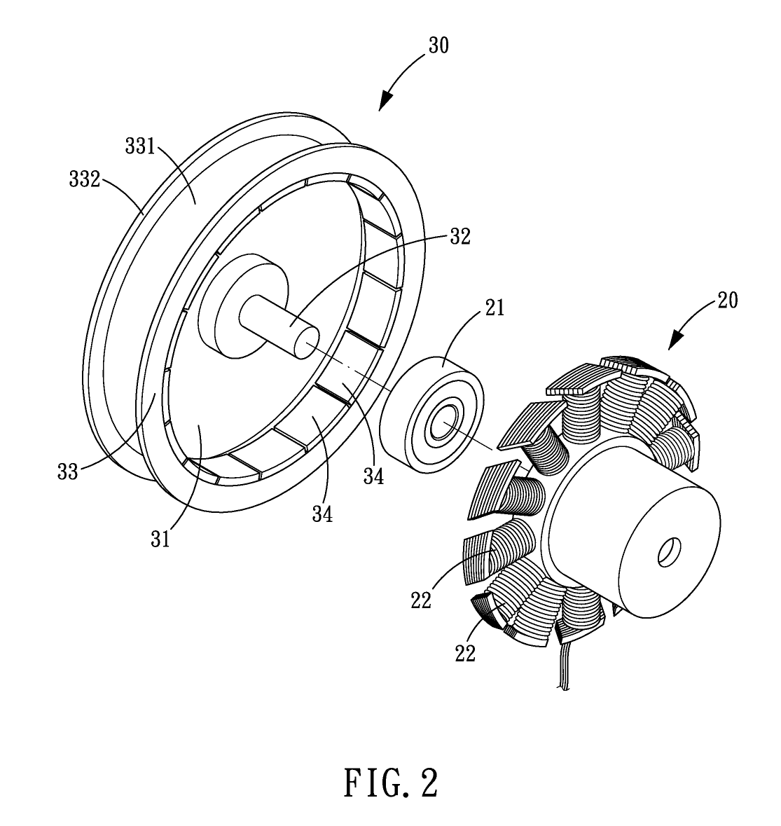

Referring to FIGS. 2-4, a belt-driven generator in accordance with the present invention is drivingly connected to a belt 41 and essentially comprises a stator 20 and a rotor 30.

The stator 20 is interiorly provided with a bearing 21 and exteriorly includes a stator magnetic field formed by plural stator coils 22 that are arranged around an outer periphery of the stator 20.

The rotor 30 includes a lateral surface 31 and a shaft portion 32 extending from a center of the lateral surface 31 to be inserted into the bearing 21 of the stator 20. The shaft portion 32 is vertical to the lateral surface 31. Furthermore, the lateral surface 31 is provided with an annular protrusion 33 extending from a circumference thereof. An extending direction of the annular protrusion 33 is the same as that of the shaft portion 32 and vertical to the lateral surface 31. The annular protrusion 33 includes a rotor magnetic field on an inner annular surface thereof, and the rotor magnetic field is formed by fixing plural permanent magnets 34 on the inner annular surface of the annular protrusion 33. The outer annular surface of the annular protrusion 33 is a driving annular surface 331, and the driving annular surface 331 is an annular plane in the present embodiment. The driving annular surface 331 is provided with a limiting protrusion 332 on each of two opposite ends thereof.

By such an arrangement, the driving annular surface 331 of the rotor 30 can be drivingly connected to the belt 41 in a contact manner so as to allow the rotor 30 to be directly driven to rotate relative to the stator 20, and the two limiting protrusions 332 of the driving annular surface 331 can avoid the slippage of the belt 41 from the driving annular surface 331.

The aforementioned is the summary of the positional and structural relationship of the respective components of the preferred embodiment in accordance with the present invention.

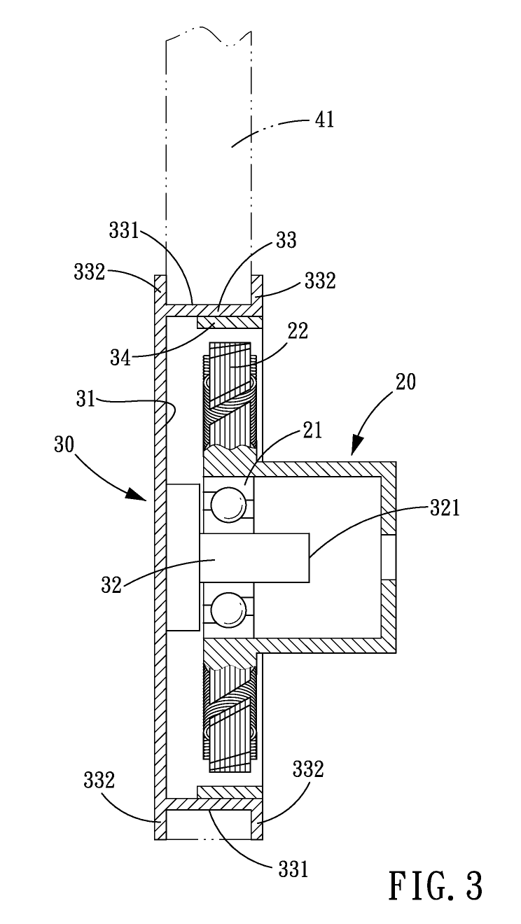

For a better understanding of the present invention, its operation and function, reference should be made to FIG. 3: being exteriorly provided with the driving annular surface 331, the rotor 30 can be driven by the drive unit 42 through a connection between the driving annular surface 331 and the belt 41 to rotate relative to the stator 20, so that the permanent magnets 34 of the rotor 30 can rotate relative to the respective stator coils 22 to produce electric power through interaction.

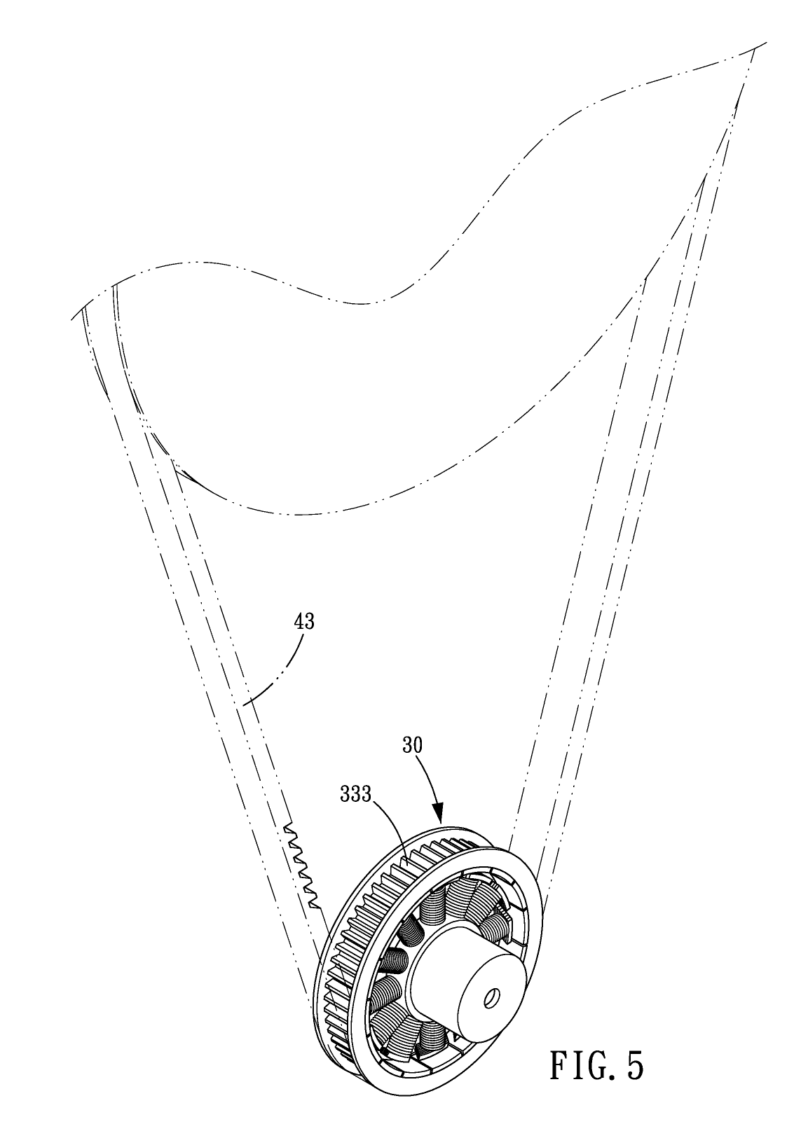

It is to be noted that, if the driving annular surface 331 of the rotor 30 is the annular plane, the connected belt 41 will be planar, so that the belt 41 can drive the rotor 30 to rotate through contact friction between the belt 41 and the driving annular surface 331, in another embodiment of the present invention, as shown in FIG. 5, if the driving annular surface of the rotor 30 is toothed, the connected belt 43 will be a toothed belt, so that the connected belt 43 can drive the rotor 30 to rotate through engagement.

With the abovementioned arrangements, the belt-driven generator in accordance with the present invention has the following advantages:

1. The rotor 30 is directly connected to the belt 41 through the driving annular surface 331 so as to be driven by the drive unit 42, so that the pivoting position of the generator (namely, the position where the shaft portion 32 of the rotor 30 is pivotally connected to the bearing 21 of the stator 20) and the driven position (namely, the position where the driving annular surface 331 of the rotor 30 is connected to the belt 41) are located on the same plane, thus preventing the pivoting position from being located excessively far away from the driven position to avoid the vibration and noise, hence, the present invention reduces the vibration and the noise through the direct-driven rotor 30 while extending the service life of the generator.

2. Since the rotor 30 of the present invention is directly connected to the belt 41 through the driving annular surface 331 so as to be driven by the drive unit 42, the prevent invention doesn't require a protruding external end and a drive wheel provided on the external end, hence, the generator of the present invention can reduce the part cost, the assembly cost and assembly space.

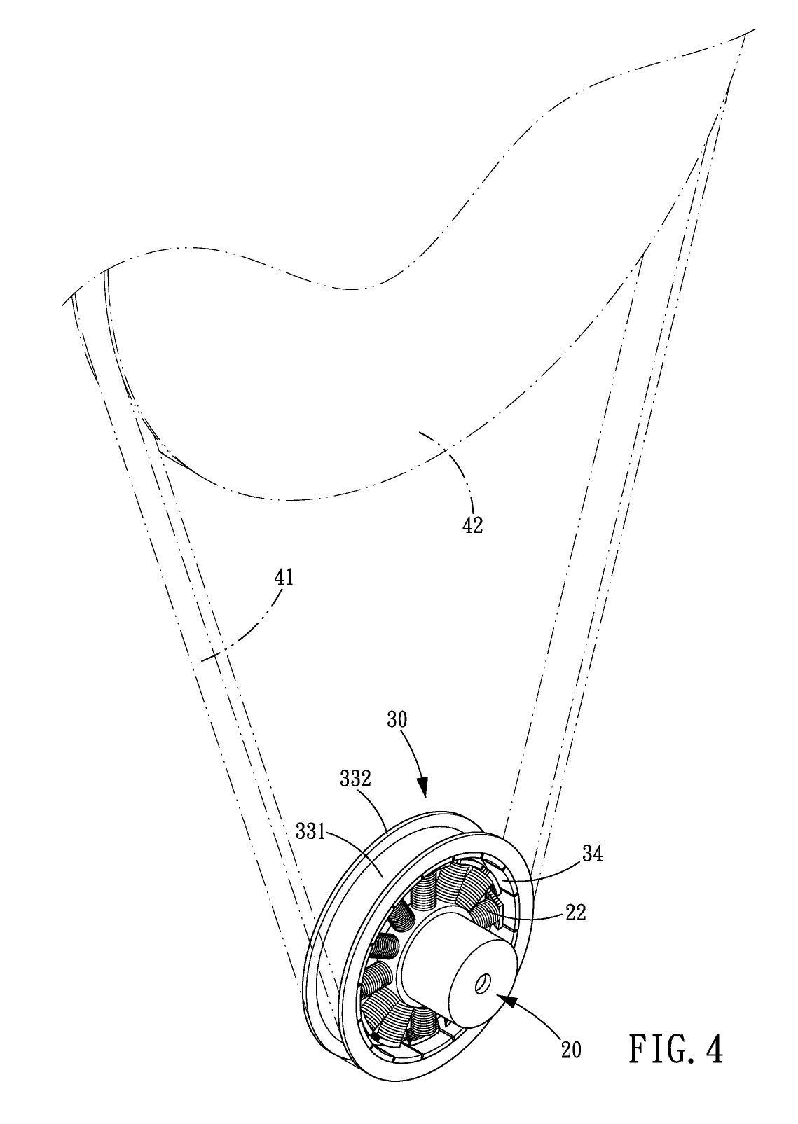

It is to be noted that, as shown in FIG. 4, after the shaft portion 32 of the rotor 30 is inserted into the bearing 21 of the stator 20 from on side of the bearing 21, a free end 321 of the shaft portion 32 will protrude from the other side of the bearing 21, such that when the rotor 30 rotates relative to the stator 20, the protruding portion of the shaft portion 32 can ensure the rotary balance of the rotor 30, preventing the rotor 30 from leaning to one side of the pivoting portion while avoiding the shake of the rotor 30.

While we have shown and described various embodiments in accordance with the present invention, it is clear to those skilled in the art that further embodiments may be made without departing from the scope of the present invention.

What is claimed is:

1. A belt-driven generator being drivingly connected to a belt and comprising:
a stator being interiorly provided with a bearing and exteriorly including a stator magnetic field; and
a rotor including a lateral surface, and a shaft portion extending from a center of the lateral surface to be inserted into the bearing of the stator, the lateral surface being provided with an annular protrusion extending from a circumference thereof, the annular protrusion including a rotor magnetic field on an inner annular surface thereof, an outer annular surface of the annular protrusion being a driving annular surface, the driving annular surface being drivingly connected to the belt in a contact manner so as to allow the rotor to be directly driven to rotate relative to the stator.

2. The belt-driven generator as claimed in claim 1, wherein the driving annular surface of the rotor is an annular plane.

3. The belt-driven generator as claimed in claim 1, wherein the driving annular surface of the rotor is toothed to be engaged with a toothed belt.

4. The belt-driven generator as claimed in claim 1, wherein the driving annular surface is provided with a limiting protrusion on each of two opposite ends thereof.
